(19) United States
(12) Patent Application Publication
(10) Pub. No.: US 2011/0287698 A1
(43) Pub. Date: Nov. 24, 2011

(54) SYSTEM, METHOD AND APPARATUS FOR ELASTOMER PAD FOR FABRICATING MAGNETIC RECORDING DISKS

(75) Inventors: Thomas E. Karis, Aromas, CA (US); Ricardo Ruiz, San Bruno, CA (US)

(73) Assignee: Hitachi Global Storage Technologies Netherlands B.V., Amsterdam (NL)

(21) Appl. No.: 12/782,023

(22) Filed: May 18, 2010

(51) Int. Cl. B24B 21/18; B32B 5/16; B32B 5/00; B32B 27/32; B32B 27/08

(52) U.S. Cl. 451/303; 428/523; 428/519; 428/516; 428/339; 428/327

(57) ABSTRACT

A pad for polishing media disks has an elastomeric body with a Shore A hardness of not greater than 20, and a coating of polystyrene (PS) and a flexible polymer. The elastomeric pad may comprise styrene-isoprene-styrene block copolymers, or a styrene-ethylene-butylene-styrene block copolymer. The pad may be viscoleastic with a particulate composite coating. The pad may be a styrenic block copolymer and the coating is a different type of styrenic block copolymer containing solid particles. The coating may have a binder with a mixture of PS and flexible styrenic block copolymers, and filler particles comprising cross-linked PS/divinylbenzene polymer microspheres.

### BACKGROUND OF THE INVENTION

1. Field of the Disclosure

The present invention relates in general to storage devices and, in particular, to a system, method and apparatus for an elastomer pad used to fabricate magnetic media disks.

2. Description of the Related Art

A process known as final tape polishing (FTP) significantly affects the manufacturing yield and quality of magnetic media disks, such as those used for mobile and desktop computer applications. One type of disk polishing or FTP tool supports a pad in a pad holder. The pad remains on the back of the abrasive tape and does not touch the rotating disk. If the pad misaligns or dislodges during FTP it causes damages to the disks. Although conventional Poron® foam pads may be used in this type of FTP tool, it would be desirable to replace it with a better pad for yield improvement and scratch reduction.

Pads were recently developed to improve yield in the FTP process. The pad applies a uniform load and conforms intimately to a backing of an abrasive tape. The abrasive tape is pressed by the pad into contact with the rotating surface of a disk. The pad is typically a soft elastomeric material (e.g., Shore A hardness of 3 to 13), such as styrene-ethylene-butylene styrene (SEBS) thermoplastic elastomer, and are referred to as soft pads.

The soft pad has a high contact area between the pad and the backing of the abrasive tape. Uniform contact improves the contact pressure uniformity compared to conventional pads. The high contact area also causes a high adhesion force between the pad and the tape during sequences known as tape advance or tape unload, resulting in a high coefficient of sliding friction. The friction force is high enough to shear the soft pad from the pad holder if the tape advances while the pad is loaded.

The occurrence of tape advance is indefinite for unpredictable intervals of time during tool operation while the pads are loaded on the disk. Moreover, tape advance cannot be distinguished from the normal operation of these types of FTP tools. While the pads are loaded, the tape is pulled in the direction of the disk rotation against the tape supply spool. Tape movement while the pads are loaded may originate from supply tape spool rotation while locked, tape stretching, and/or pad stick or slip due to relative motion between the tape and the pad holder. Thus, improvements in pad design and implementation would be desirable.

### SUMMARY

Embodiments of a system, method and apparatus for a pad for magnetic media disks are disclosed. In some embodiments, a pad for fabricating magnetic recording disks may comprise an elastomeric pad having a Shore A hardness of not greater than 20, and a coating on the elastomeric pad comprising polystyrene (PS) and a flexible polymer. The elastomeric pad may comprise styrene-isoprene-styrene (SIS) block copolymers, or a styrene-ethylene-butylene-styrene (SEBS) block copolymer. The coating may comprise PS and have a molecular weight of 100,000 to 200,000.

In other embodiments, the elastomeric pad comprises a viscoelastic material and the coating comprises a particulate composite, or a styrenic block copolymer and the coating is a different type of styrenic block copolymer containing solid particles. In still other embodiments, the elastomeric pad comprises a pure styrenic block copolymer comprising a SEBS block copolymer or blends thereof.

The coating may comprise a binder having a mixture of PS and flexible styrenic block copolymers, and filler particles comprising cross-linked PS/divinylbenzene polymer (PS/DVB) microspheres. The coating may have a thickness of 100 to 500 microns, 150 to 350 microns, or in some embodiments about 250 microns. The binder may comprise 25 wt % to 75 wt % PS. The PS of the coating may have a molecular weight of 10,000 to 500,000. The binder may comprise 40 wt % to 60 wt % PS and the molecular weight of the PS of the coating is 100,000 to 300,000. In other embodiments, the elastomeric pad comprises SIS with a molecular weight of 10,000 to 500,000. The PS/DVB microspheres may comprise 40 wt % to 90 wt % of the binder with a particle size of 1 to 100 microns, or 50 wt % to 70 wt % of the binder with the particle size of 30 to 70 microns.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a schematic side view of an embodiment of a polishing system;

FIG. 2 is a schematic side view of an embodiment of an elastomeric pad;

FIG. 3 is a plot of the frictional performance over time for several types of pads while sliding directly on the disk without polishing tape between the pad and disk;

FIG. 4 is a plot of the frictional performance over time for another type of pad application with the polishing tape between the pad and the disk; and

FIG. 5 is a schematic plot of the pressure of the polishing tape on the disk with the tape between the microtextured composite coated pad and disk.

### DETAILED DESCRIPTION

Embodiments of a system, method and apparatus for an elastomeric pad for polishing magnetic media disks are disclosed. In some versions, a topical coating is applied to a surface of the soft pad. The coating allows the soft pad to slip over the tape backing without being pulled out of the pad holder while the pad is loaded on the disk.

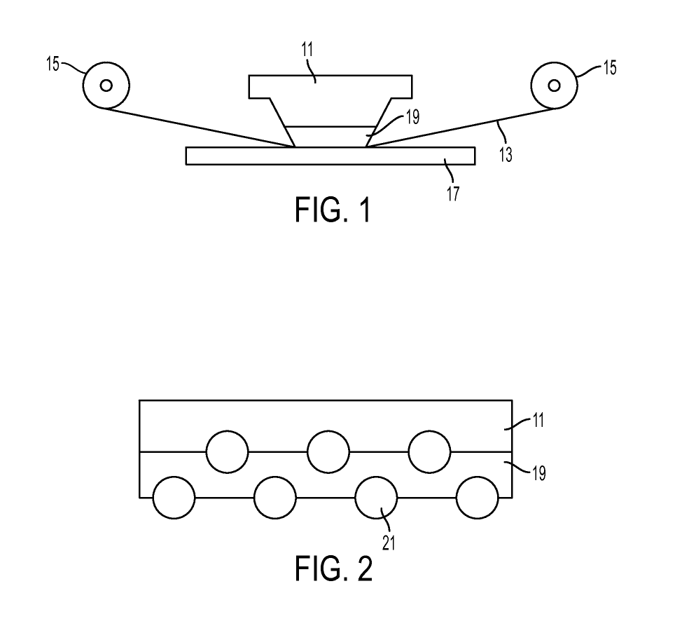

FIG. 1 schematically depicts one version of an FTP tool comprising an elastomeric pad 11 that is typically supported and restrained by a pad holder (not shown). The elastomeric pad 11 contacts and pushes a backing of an abrasive polishing tape 13 that is supported on rollers 15. An abrasive side of the tape 13, opposite pad 11, contacts and polishes a magnetic media disk 17 in operation. Embodiments of the elastomeric pad 11 include a surface coating 19 that allows the pad to slip over the tape backing when the tape 13 moves along the tape path while the pads are loaded.

It was observed that pure polystyrene has a low friction force in sliding on the backing of the polishing tape. The soft pad material may comprise polystyrene blocks, which provide the effective cross-links and impart the elastomeric network structure. Therefore increasing the polystyrene content of the soft pad surface could decrease the friction force between the soft pad and the backing.

Embodiments of a method of producing the soft pad coating are summarized below. Polystyrene (PS), such as glassy polymer polystyrene, is capable of slipping over the polishing tape but is too brittle in pure form. A lesser amount of a flexible styrenic block copolymer is dissolved with PS in a volatile organic co-solvent in which both materials are soluble, and in which the pad material also is soluble. For example, the flexible material may comprise a block copolymer styrene/isoprene/styrene (SIS) 30% styrene, which would normally stick to the polishing tape. That solution, referred to as the coating solution, is applied to the pad surface. Soft pad block copolymer styrene/ethylene/butylene/styrene (SEBS) would stick to the polishing tape.

Before the solvent evaporates, the solvent dissolves a portion of the soft pad surface, thereby mixing the pad material with the polymers in the coating solution. All three polymers may be combined in a toluene solution during the coating process. The solvent slowly evaporates, leaving behind a flexible styrene-enriched surface layer on the soft pad surface.

### Experiment 1

### Pure Polystyrene

Polystyrene was obtained by dissolving plastic sample boxes in toluene to make a 10 wt % solution. The material was verified to be polystyrene by transmission FTIR. FTIR does not detect small amounts of impurities or additives such as mineral oil. Solutions of PS with concentrations of 0.01, 0.1, 1, 5, and 10% were applied to the soft pad and tested by sliding against the backing Concentrations of less than 10% were ineffective. The coating that resulted from the 10% PS in toluene was slippery on the back of the tape. The 10 wt % PS coating made the pad surface smooth and shiny. However, the PS coating was brittle and cracked when the soft pad was flexed, stretched, or bent. Chunks of the pure 10% PS coating were not durable and delaminated and shed particles from the pad surface. Therefore the pure PS coating was not durable or acceptable for use in the manufacturing clean room.

### Experiment 2

### Polystyrene Blend with Resin

Since pure PS is too brittle, it was combined with a block copolymer that is typically used as a toner resin to make electrophotographic toners, and is more flexible than pure PS. The block copolymer tested in this case was a copolymer of styrene and butylmethacrylate. The resin was not sufficiently flexible to prevent the coating from being too brittle and cracking.

### Example 1

### PS Blend with Vector®

Flexible styrenic olefinic block copolymers from Dexco polymers were tested alone and blended with PS derived from the plastic sample boxes. Two slightly different linear block copolymers were tested, Vector® 4111A and 4211A. Both are styrene-isoprene-styrene (SIS) linear triblock copolymers with virtually no diblock. The 4111A contains 18% styrene and 4211A contains 30% styrene. Both of these SIS polymers were applied to the pads from 10% solution and were sticky. Various combinations of 4211A and PS from the plastic boxes were tested over a wide range of blend ratios and total polymer concentrations. With 95% or more PS in the blend, the coatings were brittle and cracking The addition of a fluorohydrocarbon surfactant did not improve the coating properties.

At a 5% total polymer concentration, up to three applications of coating were applied to build up the coating thickness. At a 10% total polymer concentration, only a single coating application was sufficient to deposit a substantial coating on the soft pads. In this case, a durable, slippery and flexible coating was obtained with a 75/25 blend of PS and 4211A with a total polymer concentration of 10% in toluene.

### Example 2

### PS Blend

Since it is necessary to obtain pure PS from a reproducible source, commercial PS matching the glass transition temperature was obtained from Sigma-Aldrich® (430102 Polystyrene PS, average mw of about 192,000). The coating formulation was slightly altered with this PS. Improved coating properties were obtained with 90/10 PS and 4211A at 10% in toluene. The coating blended into the pad surface layers by the solvent welding process. The coating thickness was about 50 microns.

A summary of the coating formulations that were prepared and tested is listed below in Table 1.

TABLE 1

| | | base | | | surfactant | | | | | |
|---|---|---|---|---|---|---|---|---|---|---|
| | base | polymer | | flexibilizer | Novec | | colorant | wt % of | | |
| | polymer | wt % of | flexibilizer | wt % of | 4430 wt % | colorant | wt % of | polymer in | number | |
| Date | type | polymer | type | polymer | of polymer | type | polymer | toluene | of coats | observation |
| Jun. 12, 2009 | Picco toner | 100 | — | 0 | 0 | — | — | 25 | 1 | cracked and |
| | | | | | | | | | | delaminated |
| Jun. 12, 2009 | PS box | 100 | — | 0 | 0 | — | — | 10 | 1 | cracked and |
| | | | | | | | | | | delaminated |
| Jun. 12, 2009 | ″ | 100 | — | 0 | 0 | — | — | 1 | 1 | ineffective, |
| | | | | | | | | | | too thin |
| Jun. 12, 2009 | ″ | 100 | — | 0 | 0 | — | — | 0.1 | 1 | ineffective, |
| | | | | | | | | | | too thin |
| Jun. 12, 2009 | ″ | 100 | — | 0 | 0 | — | — | 0.01 | 1 | ineffective, |
| | | | | | | | | | | too thin |
| Jun. 19, 2009 | ″ | 50 | Picco toner | 50 | 0 | — | — | 5 | 1 | cracked and |
| | | | | | | | | | | delaminated |
| Aug. 13, 2009 | V4111A | 100 | — | 0 | 0 | — | — | 10 | 1 | too sticky |
| Aug. 13, 2009 | V4211A | 100 | — | 0 | 0 | — | — | 10 | 1 | too sticky |
| Aug. 13, 2009 | PS box | 50 | V4111A | 50 | 0 | — | — | 10 | 1 | flexible |
| Aug. 13, 2009 | ″ | 50 | V4211A | 50 | 0 | — | — | 10 | 1 | flexible |
| Sep. 16, 2009 | ″ | 100 | — | 0 | 0.5 | — | — | 5 | 1 | ineffective, |
| | | | | | | | | | | too thin |
| Sep. 16, 2009 | ″ | 100 | — | 0 | 0.5 | — | — | 5 | 3 | cracked and |
| | | | | | | | | | | delaminated |
| Sep. 17, 2009 | ″ | 80 | V4211A | 20 | 3 | — | — | 5 | 3 | less cracking |
| Sep. 28, 2009 | ″ | 95 | ″ | 5 | 0 | — | — | 5 | 3 | less cracking |
| Sep. 28, 2009 | ″ | 97.5 | ″ | 2.5 | 0 | — | — | 5 | 3 | more cracking |
| Sep. 29, 2009 | ″ | 95 | ″ | 5 | 4 | — | — | 5 | 1 | cracking |
| Sep. 29, 2009 | ″ | 95 | ″ | 5 | 4 | — | — | 5 | 2 | cracking |
| Sep. 29, 2009 | ″ | 95 | ″ | 5 | 4 | — | — | 5 | 3 | cracking |
| Sep. 29, 2009 | ″ | 97.5 | ″ | 2.5 | 4 | — | — | 5 | 1 | cracking |
| Sep. 29, 2009 | ″ | 97.5 | ″ | 2.5 | 4 | — | — | 5 | 2 | cracking |
| Sep. 29, 2009 | ″ | 97.5 | ″ | 2.5 | 4 | — | — | 5 | 3 | cracking |
| Sep. 30, 2009 | ″ | 92.5 | ″ | 7.5 | 0 | — | — | 5 | 1 | brittle and |
| | | | | | | | | | | cracking |
| Sep. 30, 2009 | ″ | 92.5 | ″ | 7.5 | 0 | — | — | 5 | 2 | brittle and |
| | | | | | | | | | | cracking |
| Sep. 30, 2009 | ″ | 92.5 | ″ | 7.5 | 0 | — | — | 5 | 3 | brittle and |
| | | | | | | | | | | cracking |
| Sep. 30, 2009 | ″ | 90 | ″ | 10 | 4 | — | — | 5 | 1 | brittle and |
| | | | | | | | | | | cracking |
| Sep. 30, 2009 | ″ | 90 | ″ | 10 | 4 | — | — | 5 | 2 | brittle and |
| | | | | | | | | | | cracking |
| Sep. 30, 2009 | ″ | 90 | ″ | 10 | 4 | — | — | 5 | 3 | brittle and |
| | | | | | | | | | | cracking |
| Oct. 1, 2009 | ″ | 90 | ″ | 10 | 0 | carbon black | 13.4 | 5 | 1 | cracking, |
| | | | | | | | | | | not dispersed |
| Oct. 1, 2009 | ″ | 90 | ″ | 10 | 0 | blue tint | 13.4 | 5 | 1 | cracking, |
| | | | | | | | | | | bleeding color |
| Oct. 1, 2009 | ″ | 50 | ″ | 50 | 0 | ″ | 3.2 | 10 | 1 | good color, |
| | | | | | | | | | | peeling |
| Oct. 6, 2009 | ″ | 75 | ″ | 25 | 0 | ″ | 3.6 | 10 | 1 | good color, |
| | | | | | | | | | | good slip |
| Oct. 20, 2009 | Aldrich PS | 75 | ″ | 25 | 0 | ″ | 3.3 | 10 | 1 | sticky, peeling |
| Oct. 21, 2009 | ″ | 90 | ″ | 10 | 0 | ″ | 3.6 | 10 | 1 | good, submitted |
| | | | | | | | | | | for test |

### Example 3

### Solvent Welding Soft Pad Material to Polystyrene

Since it was observed that the coating welds itself into the soft pad surface even though the soft pad material is only partly made from PS, it is reasonable that the same coating formulation could be used to firmly weld SEBS polymers to solid PS. The flexible coating made by blending the flexible 4211A with the PS makes the coating suitable for bonding the soft elastic solids to rigid PS than rigid cements. The durability of the bond to the flexible pad and a rigid PS support is desirable when it is used as a polishing or wiping pad because it undergoes repeated cyclical stress and deformation. Cyanoacrylate adhesives often fatigue and fail after several hundred polishing cycles.

These versions of the coating reduce the adhesion between the pad and the backing of the polishing tape. The coating allows slippage of the tape relative to the pad during the disk polishing process. In some applications, however, the coating has sufficient friction such that it does not allow the pad to slide on the disk without fracturing or smearing onto the disk. Some disks may be scrapped in manufacturing because of accidental contact between the tape and disk. Therefore, for some applications, embodiments of the pad face coating allow occasional contact of the pad with the disk during the disk polishing or wiping operation without pad damage or significant smearing on the disks.

Composite Coatings

Accordingly, some embodiments of the coating do not change the desirable viscoelastic response properties of the elastomeric pad material. This performance can be accomplished by reducing the friction between the pad surface and the disk. In some embodiments, friction reduction between the pad and the disk is accomplished by adding solid particles 21 (FIG. 2) to the binder 19 to form a composite coating. The solid particles provide low friction load bearing contacts between the pad and the disk.

The solid particles may be completely bonded to the binder so that they do not fall out of the coating. For example, the initial binder may comprise a toluene solution of PS and, for flexibility, a SIS copolymer. When the binder is coated onto the soft pad surface, the toluene also dissolves the surface of the pad styrenic material. As the binder evaporates, the glassy phase of the pad material reforms, but it then also contains styrene blocks from the PS and SIS in the binder. This process is somewhat analogous to the mechanism of solvent welding.

If the solid particles are PS, which may be lightly cross-linked with divinylbenzene (PS/DVB), the particles swell in the toluene and intermix by diffusion with the styrene blocks of the PS/SIS binder. When the toluene solvent evaporates, the glassy phases reform. The surfaces of the PS/DVB solid particles (e.g., microspheres) then contain segments from the PS/SIS binder. The binder, particles and pad surface are then interconnected with each other by the glassy phases of the components. This is a single material below the melting temperature of the glassy phase (e.g., about 100° C.).

For example, various proportions of PS/SIS may be used to make a flexible binder with a sufficient content of the solid microspheres to provide a low friction and wear interface.

### Example 1

PS/DVB microspheres were used to provide load support. They were 200-400 mesh (37 to 74 μm), 2% DVB. The microspheres were added to the binder solution. The binder was initially a 10 wt % solution of PS and SIS in toluene. The PS had a molecular weight of about 192,000. The PS coating is made flexible by adding a flexible polymer Vector® 4211A, SIS triblock copolymer with 30% styrene. The soft pads were a 50/50 blend of GLS Dynaflex® G6713 (13 Shore A hardness) and Versaflex® CL2000X (03 Shore A hardness). They are both styrenic block copolymers with a hydrogenated midblock of SEBS.

Embodiments of pad coating formulations were prepared and coated onto pads for evaluation. Each coating was evaluated by inspection to test the flexibility of the coating, and by rubbing on a disk at 1000 rpm to qualitatively measure the friction force and smear. The formulations tested and the observations are listed in Table 2. For example, the formulation comprising 66% PS/DVB in 50/50 PS/SIS binder performed well.

TABLE 2

| PS-DVB % | Binder | Binder % | | | Disk | Disk | |
|---|---|---|---|---|---|---|---|
| Of Binder | PS/SIS | In Toluene | Application | Thickness | Smear | Friction | Cracking |
| 0 | 90/10 | 10 | Brush | Thin | Yes | High | No |
| 20 | — | — | Brush | Thin | Yes | High | — |
| 40 | 90/10 | 10 | Brush | Thin | Yes | High | Yes |
| 50 | 90/10 | 10 | Brush | Thin | Yes | High | Yes |
| 60 | 90/10 | 10 | Blade | Thick | No | Low | Yes |
| 50 | 75/25 | 10 | Brush | Thin | Yes | High | No |
| 50 | 75/25 | 10 | Brush | Thick | Yes | High | Yes |
| 50 | 50/50 | 10 | Brush | Thin | Yes | High | No |
| 60 | 50/50 | 10 | Brush | Thin | Yes | High | No |
| 66 | 50/50 | 10 | Brush | Thin | Yes | High | Yes |
| 66 | 50/50 | 10 | Blade | Thick | No | Low | Some |

### Example 2

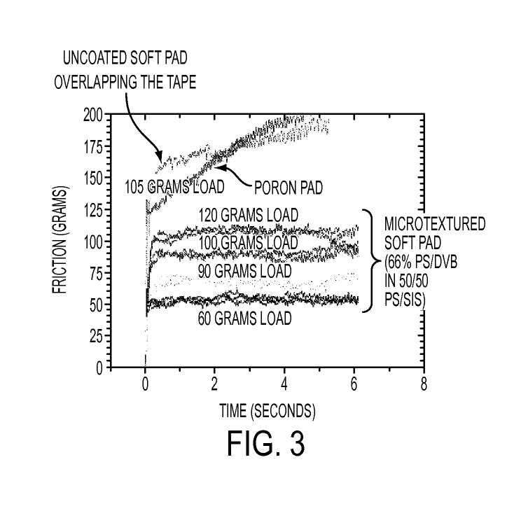

The soft pad that was microtextured with 66% PS/DVB in 50/50 PS/SIS binder from the last row of Table 2 was selected for friction measurement with the pad directly on the disk. Measurements were done with a typical polishing pass sweep rate (1.67 mm/sec) and linear velocity (2 m/sec). In the first set of tests the polishing pass was done without any polishing tape, and the pad was directly in contact with the disk. The friction during the sweep for a typical, uncoated foam pad also was included. The friction test results are shown in FIG. 3 and summarized in Table 3. The microtextured soft pad has much lower friction and little or no smear on the disk.

TABLE 3

| | Load | OD Friction | Friction |
|---|---|---|---|
| Sample | Grams | Grams | Coefficient |
| Poron pad on disk | 105 | 205.5 | 1.96 |
| Uncoated soft pad overlapping tape | 105 | 191.8 | 1.83 |
| Microtextured soft pad on disk | 100 | 92.2 | 0.92 |

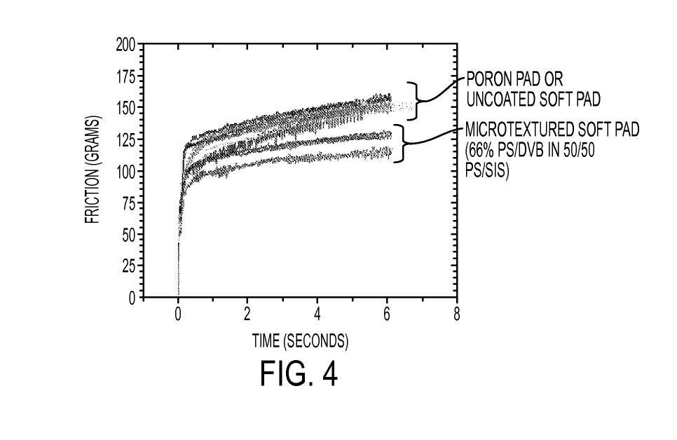

The polishing friction of the microtextured soft pad also was compared to the Poron® pad and the uncoated soft pad in the normal polishing configuration with the polishing tape between the pad and the disk. The friction results from this test are shown in FIG. 4. and summarized in Table 4. The polishing tape friction with the microtextured soft pad is significantly lower than those other pads. The microtextured soft pad also may have an improved glide yield and reduced disk scratch because of the lower polishing friction.

TABLE 4

| | Load | OD Friction | Friction |
|---|---|---|---|
| Sample | Grams | Grams | Coefficient |
| Poron pad on tape | 105 | 145.8 | 1.39 |
| Uncoated soft pad on tape | 105 | 151.8 | 1.47 |
| Microtextured soft pad on tape | 100 | 123.2 | 1.23 |

### Example 3

Ten gram stock solutions of the binder polymers were prepared with a concentration of 10 wt % in toluene in separate glass vials. For the PS stock solution, one gram of PS with an average mw of about 192,000 was combined with 9 grams of toluene. For the SIS stock solution, one gram of Vector® 4211A was combined with 9 grams of toluene. The 4211A contains 30% styrene. The vials containing the mixtures of polymer pellets in toluene were placed on a roll mill overnight to completely dissolve the polymer.

Five grams of 50/50 PS/SIS binder solution at 10 wt % in toluene was made by combining 2.5 grams of the 10% PS stock solution and 2.5 grams of the 10% SIS stock solution in a glass vial. This vial contains 0.5 grams of PS/SIS solids and 4.5 grams of volatile toluene solvent, 10% binder solution.

The microtextured composite coating formulation was prepared by adding 0.95 grams of PS/DVB microspheres into the vial containing the 10% binder solution. The PS/DVB microspheres are 200-400 mesh (37 to 74 μm), 2% DVB. This mixture was stirred on a vortex mixer to obtain a thixotropic slurry. The percentage of microspheres in the composite coating is then 100*0.95/(0.95+0.5)=66%. This coating slurry is referred to as 66% PS/DVB in 50/50 PS/SIS.

Uniform Coating Thickness

A fixture was used to obtain uniform thickness of the coating the slurry on the surface of the FTP polishing soft pads. The soft pads were a 50/50 blend of GLS Dynaflex® G6713 (13 Shore A hardness) and Versaflex® CL2000X (03 Shore A hardness). They are both styrenic block copolymer with a hydrogenated midblock of SEBS.

The fixture was a plate with cavities to hold the pads with the pad faces recessed about 0.2 mm below the top surface of the plate. This fixture is also referred to as the pad coating form block. The 66% PS/DVB in 50/50 PS/SIS slurry was placed in the cavities. Before the toluene evaporates, the puddle of slurry is “doctor bladed” across the surface of the plate, leaving the uniform thickness of slurry in the cavity above the pad face.

Several plate thicknesses of 5.2, 5.3, and 5.4 mm were evaluated to obtain coatings of various thicknesses. The 5.2 mm plate left only a few microspheres on the pad face. The coating deposited from 5.3 mm plate was variable due to the flatness tolerances of the pad face when inserted into the cavities. The coating deposited from the 5.4 mm thick plate was of good quality and uniformity and was selected to use for further testing. The coating dried for several hours at ambient conditions before removing the microtextured pad from the plate. One of the fresh coatings was dried in a vacuum oven at 65° C., which created delaminations within the coating layer and could not be used.

When the pads were removed from the form block, the coating was uniform and strongly bonded into the pad. The coating was approximately 0.25 mm thick.

Pad on Disk Friction Test

Microtextured FTP soft pads were prepared with the 66% PS/DVB in 50/50 PS/SIS and the 5.4 mm thick coating form block for friction and wear measurements. In these tests, the pad was loaded on the spinning disk with a specified load near the inside diameter, and the pad traversed across the disk while the rotation rate was adjusted to maintain constant linear velocity. The pad unloaded from the disk at the outer diameter. The linear velocity was 2 msec, radial velocity 1.67 mm/sec, load radius 14 mm, and the unload radius was 27 mm on a 65 mm diameter lubricated mobile disk.

For some of the tests, the pad was applied directly to the disk. This verified the friction and wear reduction of the microtextured pad coating in contact with the disk. An uncoated pad makes a heavy smear on the disk and is torn from the holder by the excessively high friction. In other tests, the microtextured pad was applied to the back of the abrasive polishing tape, and the tape was pressed onto the disk as in the normal disk polishing configuration. These latter tests examine the potential for microtexture as a means to control the tape friction.

The first set of friction tests on the microtextured pads was done at a series of increasing loads with the pad directly on the disk. The same pad and a fresh disk were used for each test. The loads were 50, 70, 100, and 120 grams. The pad became unstable and flew out of the holder in the last test at 120 grams load. The friction force and coefficient are listed in Table 5. The second set of friction tests was done to verify the pad stability at 120 grams load, since it became unstable at 120 grams load in the first set of tests. The pad showed no sign of wear or damage during three traverses at 120 grams load. There was a gradual increase in the friction force with the number of sweeps (see Table 5). In all of the friction sweep tests with the microtextured soft FTP pad on the disk, there was a faintly visible transfer film deposited on the disk. Nothing like the heavy smear from even a slight overlapping of the uncoated pad onto the disk. Thus, the microtextured pad coating solved the pad wear problems observed in manufacturing.

TABLE 5

| | | Load | OD Friction | Friction |
|---|---|---|---|---|
| Sample | Configuration | Grams | Grams | Coefficient |
| Microtextured | Pad on disk | 50 | 50.7 | 1.01 |
| Pad 1, sweep 1 | | | | |
| Microtextured | Pad on disk | 70 | 82 | 1.17 |
| Pad 1, sweep 2 | | | | |
| Microtextured | Pad on disk | 100 | 99.7 | 1.00 |
| Pad 1, sweep 3 | | | | |
| Microtextured | Pad on disk | 120 | Fell out | — |
| Pad 1, sweep 4 | | | | |
| Microtextured | Pad on disk | 120 | 93.4 | 0.78 |
| Pad 2, sweep 1 | | | | |
| Microtextured | Pad on disk | 120 | 108 | 0.90 |
| Pad 2, sweep 2 | | | | |
| Microtextured | Pad on disk | 120 | 118.4 | 0.99 |
| Pad 2, sweep 3 | | | | |
| Uncoated Pad | Pad on tape | 120 | 175.2 | 1.46 |
| Microtextured | Pad on tape | 120 | 111.8 | 0.93 |
| Pad 2 | | | | |

Pad on Tape Friction Test

A further benefit of the microtextured soft FTP pad is that it favorably alters the contact geometry between the tape and the disk. Normally the friction between the tape and the disk with an uncoated FTP pad is very high, indicating that unnecessary work is being done on the disk carbon overcoat during the disk polishing process when the goal is only cleaning of the disk and removal of several dozen or a few hundred micron scale defects on the disk surface. The same is true for the disk wiping and pad wipe processes. The friction coefficients are listed in the last two rows of Table 5. In some embodiments, the FTP tape friction force and friction coefficient is 40% less with the microtextured soft pad compared to conventional solutions.

Friction Reduction Mechanism

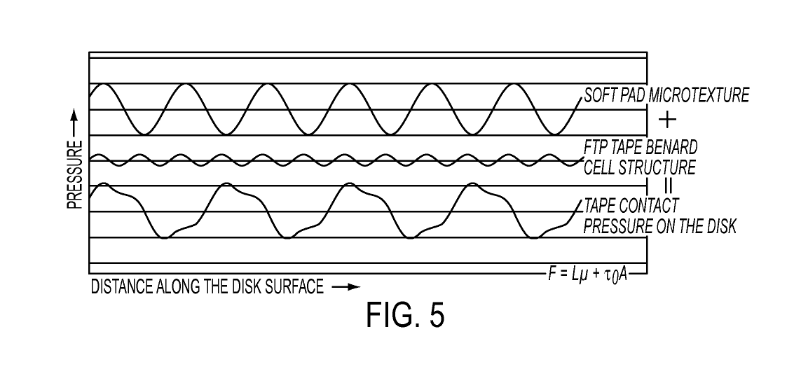

The pad on disk friction force is proportional to the load. The tape friction reduction by the microtextured pad face also is attributed to a decrease in the contact area between the tape and the disk. The mechanism of the contact area reduction by the microtexture is schematically shown in FIG. 5. The surface topography is rendered as a sine wave for illustration. The middle trace shows the pressure distribution under the tape with an uncoated pad resulting from the Benard cell topography of the tape coating.

The pressure profile of the microtextured pad is depicted in the upper trace, which is more widely separated, and has higher amplitude due to the 30 to 70 μm size distribution of the microspheres in the pad coating. The pressure profile of the combined tape and disk is depicted by the lower trace. The details of the curve vary depending on the details of the random variations in the pad and tape microtopography. The result in any case is that the tape has fewer contact points on the disk, with higher pressures, and a larger low pressure pocket in between than are provided by the Benard cell topography alone.

In some embodiments, a pad for fabricating magnetic recording disks may comprise an elastomeric pad having a Shore A hardness of not greater than 20, and a coating on the elastomeric pad comprising PS and a flexible polymer. The elastomeric pad may comprise SIS block copolymers, or a SEBS block copolymer. The coating may comprise PS and have a molecular weight of 100,000 to 200,000.

In other embodiments, the elastomeric pad comprises a viscoelastic material and the coating comprises a particulate composite, or a styrenic block copolymer and the coating is a different type of styrenic block copolymer containing solid particles. In still other embodiments, the elastomeric pad comprises a pure styrenic block copolymer comprising a SEBS block copolymer or blends thereof.

The coating may comprise a binder having a mixture of PS and flexible styrenic block copolymers, and filler particles comprising cross-linked PS/DVB microspheres. The coating may have a thickness of 100 to 500 microns, 150 to 350 microns, or in some embodiments about 250 microns. The binder may comprise 25 wt % to 75 wt % PS. The PS of the coating may have a molecular weight of 10,000 to 500,000. The binder may comprise 40 wt % to 60 wt % PS and the molecular weight of the PS of the coating is 100,000 to 300,000. In other embodiments, the elastomeric pad comprises SIS with a molecular weight of 10,000 to 500,000. The PS/DVB microspheres may comprise 40 wt % to 90 wt % of the binder with a particle size of 1 to 100 microns, or 50 wt % to 70 wt % of the binder with the particle size of 30 to 70 microns.

Embodiments of the microtextured soft pad provide numerous advantages for the disk manufacturing process. The microtextured soft pad friction is decreased by reduction in contact area between the soft pad and disk, or between the FTP tape and disk. The pad microtexture improves FTP defect removal by peak pressure amplification, and decreases circumferential scratch defects by providing larger low pressure pockets for trapped particles. Other advantages over conventional solutions include ease of application of the coating, and it is well suited for use in manufacturing clean room environments. The coating also is very thin and has a negligible effect on the pad surface contact mechanical properties.

In some embodiments, the elastomer pad may comprise styrenic elastomer, a diene elastomer, an olefinic elastomer, polyurethane, silicone rubber, or any combination thereof. An exemplary styrenic elastomer includes a polymer having at least one block of polystyrene, such as acrylonitrile butadiene styrene copolymer (ABS), styrene-butadiene (SB), styrene-butadiene-styrene (SBS), styrene-isoprene-styrene (SIS), styrene-isoprene (SI), styrene-ethylene-butylene-styrene (SEBS), styrene-ethylene-butylene (SEB), styrene-ethylene-propylene-styrene (SEPS), styrene-ethylene-propylene (SEP), or a combination thereof. A diene elastomer is a cross-linkable copolymer including a diene monomer, for example, ethylene propylene diene monomer (EPDM), ABS, or a combination thereof. An exemplary olefinic elastomer include elastomeric varieties of polyolefin, for example, a polyolefin homopolymer, such as polyethylene, polypropylene, polybutene, polypentene, polymethylpentene, or a combination thereof; a polyolefin copolymer, such as ethylene-propylene copolymer, ethylene-butene copolymer, ethylene-octene copolymer, or a combination thereof; or a combination thereof.

An exemplary polyurethane is a product of a polyol and a diisocyante. The polyurethane can be a two-component polyurethane or a one-component polyurethane. In particular, the one-component polyurethane precursor is the reaction product of a polyol and an excess amount of isocyanate, resulting in a polyurethane precursor terminated with isocyanate groups. In the presence of water, a portion of the isocyanate groups are converted into amine groups, which react with the remaining isocyanate groups resulting in a chemically cross linked polyurethane network. Carbon dioxide released during this process can help the foaming process.

An exemplary silicone rubber may, for example, include elastomeric varieties of polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS).

In another example, the silicone polymer can include a polar silicone, such as silicone including halide functional groups, such as chlorine and fluorine, and silicone including phenyls functional groups. For example, the silicone can include trifluoropropylmethylsiloxane polymers. In another exemplary embodiment, the silicone can include polyphenyl methyl siloxane.

In a particular example, the elastomer is at least partially soluble in a solvent in which polystyrene is soluble. For example, the elastomer can be a styrenic elastomer. An exemplary styrenic block copolymer includes a polymer having at least one block of polystyrene, such as acrylonitrile butadiene styrene copolymer (ABS), styrene-butadiene (SB), styrene-butadiene-styrene (SBS), styrene-isoprene-styrene (SIS), styrene-isoprene (SI), styrene-ethylene-butylene-styrene (SEBS), styrene-ethylene-butylene (SEB), styrene-ethylene-propylene-styrene (SEPS), styrene-ethylene-propylene (SEP), or a combination thereof. In a particular example, the styrenic block copolymer includes styrene-isoprene-styrene. In another example, the styrenic block copolymer includes styrene-ethylene-butylene-styrene (SEBS).

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A pad for fabricating magnetic recording disks, comprising:
an elastomeric pad having a Shore A hardness of not greater than 20; and
a coating on the elastomeric pad comprising polystyrene (PS) and a flexible polymer.

2. A pad according to claim 1, wherein the elastomeric pad comprises styrene-isoprene-styrene (SIS) block copolymers.

3. A pad according to claim 1, wherein the elastomeric pad comprises a styrene-ethylene-butylene-styrene (SEBS) block copolymer.

4. A pad according to claim 1, wherein the coating comprises polystyrene and has a molecular weight of 100,000 to 200,000.

5. A pad according to claim 1, wherein the elastomeric pad comprises a viscoleastic material and the coating comprises a particulate composite.

6. A pad according to claim 1, wherein the elastomeric pad comprises a styrenic block copolymer and the coating is a different type of styrenic block copolymer containing solid particles.

7. A pad according to claim 1, wherein the elastomeric pad comprises a pure styrenic block copolymer comprising a styrene-ethylene-butylene-styrene (SEBS) block copolymer or blends thereof.

8. A pad according to claim 1, wherein the coating comprises a binder having a mixture of polystyrene and flexible styrenic block copolymers, and filler particles comprising cross-linked polystyrene/divinylbenzene polymer (PS/DVB) microspheres.

9. A pad according to claim 8, wherein the coating has a thickness of 100 to 500 microns.

10. A pad according to claim 8, wherein the coating has a thickness of 150 to 350 microns.

11. A pad according to claim 8, wherein the binder comprises 25 wt % to 75 wt % polystyrene.

12. A pad according to claim 8, wherein the polystyrene of the coating has a molecular weight of 10,000 to 500,000.

13. A pad according to claim 8, wherein the binder comprises 40 wt % to 60 wt % polystyrene and the molecular weight of the polystyrene of the coating is 100,000 to 300,000.

14. A pad according to claim 8, wherein the elastomeric pad comprises styrene-isoprene-styrene (SIS) with a molecular weight of 10,000 to 500,000.

15. A pad according to claim 8, wherein the PS/DVB microspheres comprise 40 wt % to 90 wt % of the binder with a particle size of 1 to 100 microns.

16. A pad according to claim 8, wherein the PS/DVB microspheres comprise 50 wt % to 70 wt % of the binder with the particle size of 30 to 70 microns.

17. A machine, comprising:
an abrasive tape mounted to rollers for circulating the abrasive tape therebetween;
a pad located on one side of the abrasive tape and adapted to push an abrasive surface of the abrasive tape against a surface of a magnetic media disk for polishing the magnetic media disk; the pad comprising:
an elastomeric pad having a Shore A hardness of not greater than 20; and
a coating on the elastomeric pad comprising polystyrene (PS) and a flexible polymer.

18. A machine according to claim 17, wherein the elastomeric pad comprises styrene-isoprene-styrene (SIS) block copolymers or a styrene-ethylene-butylene-styrene (SEBS) block copolymer.

19. A machine according to claim 17, wherein the coating comprises polystyrene and has a molecular weight of 100,000 to 200,000, and the elastomeric pad comprises a viscoleastic material and the coating comprises a particulate composite.

20. A machine according to claim 17, wherein the elastomeric pad comprises a styrenic block copolymer or a pure styrenic block copolymer comprising a styrene-ethylene-butylene-styrene (SEBS) block copolymer or blends thereof, and the coating is a different type of styrenic block copolymer containing solid particles.

21. A machine according to claim 17, wherein the coating comprises a binder having a mixture of polystyrene and flexible styrenic block copolymers, and filler particles comprising cross-linked polystyrene/divinylbenzene polymer (PS/DVB) microspheres.

22. A machine according to claim 21, wherein the coating has a thickness of 100 to 500 microns, or 150 to 350 microns.

23. A machine according to claim 21, wherein the binder comprises 25 wt % to 75 wt % polystyrene, the polystyrene of the coating has a molecular weight of 10,000 to 500,000.

24. A machine according to claim 21, wherein the binder comprises 40 wt % to 60 wt % polystyrene, the molecular weight of the polystyrene of the coating is 100,000 to 300,000, and the elastomeric pad comprises styrene-isoprene-styrene (SIS) with a molecular weight of 10,000 to 500,000.

25. A machine according to claim 21, wherein the PS/DVB microspheres comprise 40 wt % to 90 wt % of the binder with a particle size of 1 to 100 microns, or 50 wt % to 70 wt % of the binder with the particle size of 30 to 70 microns.
